(19) United States
(12) Patent Application Publication
(10) Pub. No.: US 2022/0198335 A1
(43) Pub. Date: Jun. 23, 2022

(54) METHOD AND APPARATUS FOR COLLECTING DATA OF ARTIFICIAL INTELLIGENCE SYSTEM

(71) Applicant: ELECTRONICS AND TELECOMMUNICATIONS RESEARCH INSTITUTE, Daejeon (KR)

(72) Inventor: Seung Hyun YOON, Daejeon (KR)

(73) Assignee: ELECTRONICS AND TELECOMMUNICATIONS RESEARCH INSTITUTE, Daejeon (KR)

(21) Appl. No.: 17/557,754

(22) Filed: Dec. 21, 2021

(30) Foreign Application Priority Data
Dec. 21, 2020 (KR) 10-2020-0180255

(51) Int. Cl. G06N 20/00

(52) U.S. Cl. CPC G06N 20/00

(57) ABSTRACT

A method and an AI system for collecting data on demand by starting data collection based on a predetermined data configuration of data required for development of AI model when design of the AI model starts on the AI system; storing raw data collected through the data collection and generating data processed for AI model learning or machine learning (ML) by pre-processing the raw data; and completing the development of the AI model by learning and validating the AI model designed based on the raw data and/or pre-processed data are provided.

### CROSS-REFERENCE TO RELATED APPLICATION

This application claims priority to and the benefit of Korean Patent Application No. 10-2020-0180255 filed in the Korean Intellectual Property Office on Dec. 21, 2020, the entire contents of which are incorporated herein by reference.

### BACKGROUND OF THE INVENTION

### Field of the Invention

The present disclosure relates to a method and a device for data collection of an artificial intelligence system.

### (b) Description of the Related Art

An artificial intelligence (AI) system (or AI platform) is a system used to develop AI (or machine learning) models. The AI system can learn the designed AI model using data and verify the learned AI model using data. For the AI systems, several commercial products and opensource projects combined with cloud environments are being actively published. In general, data-based supervised learning is widely used, and most AI platforms can also be constructed mainly by data-based supervised learning functions.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An embodiment provides a method for collecting data for AI (AI) system Another embodiment provides an artificial intelligence (AI) system using on-demand data.

Yet another embodiment provides an artificial intelligence (AI) system collecting data on demand.

According to an embodiment, a method for collecting data of AI (AI) system is provided. The method includes: starting data collection based on a predetermined data configuration of data required for development of AI model when design of the AI model starts on the AI system; storing raw data collected through the data collection and generating data processed for AI model learning or machine learning (ML) by pre-processing the raw data; and completing the development of the AI model by learning and validating the AI model designed based on the raw data and/or pre-processed data.

The predetermined data configuration may include a measurement profile of the data required for the development of the AI model, and the starting data collecting may include measuring data in a network according to the measurement profile.

The measuring data in a network according to the measurement profile may include determining raw data to be collected according to the measurement profile and determining collection location and collection target for the raw data.

The predetermined data configuration may further include a pre-processing profile of the data required for the development of the AI model, and the generating data processed for ML by pre-processing the raw data may include pre-processing the raw data according to the pre-processing profile.

The predetermined data configuration may further include a data storing process profile of the data required for the development of the AI model, and the method may further include storing the raw data and the pre-processed data according to the data storing process profile after the generating data processed for ML by pre-processing the raw data.

According to another embodiment, an artificial intelligence (AI) system using on-demand data is provided. The AI system includes: an AI platform module configured to request data collection of data required for development of AI model when design of the AI model starts on the AI system; an on-demand data collection and processing control module configured to perform the data collection based on a predetermined data configuration of the data required for the development of the AI model; and a data pre-processing module configured to store the raw data collected through the data collection and generate data processed for AI model learning or machine learning (ML) by pre-processing the raw data, wherein the AI platform module completes the development of the AI model by learning and verifying the AI model designed based on the raw data and/or pre-processed data.

The predetermined data configuration may include a measurement profile of the data required for the development of the AI model, and the on-demand data collection and processing control module may be further configured to measure data in a network according to the measurement profile.

The on-demand data collection and processing control module may be further configured to determine the raw data to be collected according to the measurement profile and determine collection location and collection target for the raw data.

The predetermined data configuration may further include a pre-processing profile of the data required for the development of the AI model, and the data pre-processing module may be further configured to pre-processes the raw data according to the pre-processing profile.

The predetermined data configuration may further include a data storing process profile of the data required for the development of the AI model, and the data pre-processing module may be configured to store the raw data and the data processed for the ML in a data storage module according to the data storing process profile.

According to yet another embodiment, an artificial intelligence (AI) system collecting data on demand is provided. The AI system includes a processor, a memory, and a communication device, wherein the processor executes a program stored in the memory to perform: starting data collection through the communication device based on a predetermined data configuration of data required for development of AI model when design of the AI model starts on the AI system; storing raw data collected through the data collection and generating data processed for AI model learning or machine learning (ML) by pre-processing the raw data; and completing the development of the AI model by learning and validating the AI model designed based on the raw data and/or pre-processed data.

### BRIEF DESCRIPTION OF THE DRAWINGS

FIG. 1 is a block diagram illustrating an AI system using on-demand data according to an embodiment.

FIG. 2 is a flowchart illustrating a method for data collection of an AI system according to an embodiment.

FIG. 3 is a block diagram illustrating an AI system according to another embodiment.

### DETAILED DESCRIPTION OF THE EMBODIMENTS

In the following detailed description, only certain embodiments have been shown and described, simply by way of illustration. As those skilled in the art would realize, the described embodiments may be modified in various different ways, all without departing from the spirit or scope of the description. Accordingly, the drawings and description are to be regarded as illustrative in nature and not restrictive, and like reference numerals designate like elements throughout the specification.

Throughout the specification, unless explicitly described to the contrary, the word “comprise”, and variations such as “comprises” or “comprising”, will be understood to imply the inclusion of stated elements but not the exclusion of any other elements.

In this specification, expressions described in the singular may be construed in the singular or plural unless an explicit expression such as “one” or “single” is used.

As used herein, “and/or” includes each and every combination of one or more of the recited elements.

In the specification, it will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present description.

In a flowchart described with reference to drawings in this specification, the order of operations may be changed, several operations may be merged, some operations may be divided, and specific operations may not be performed.

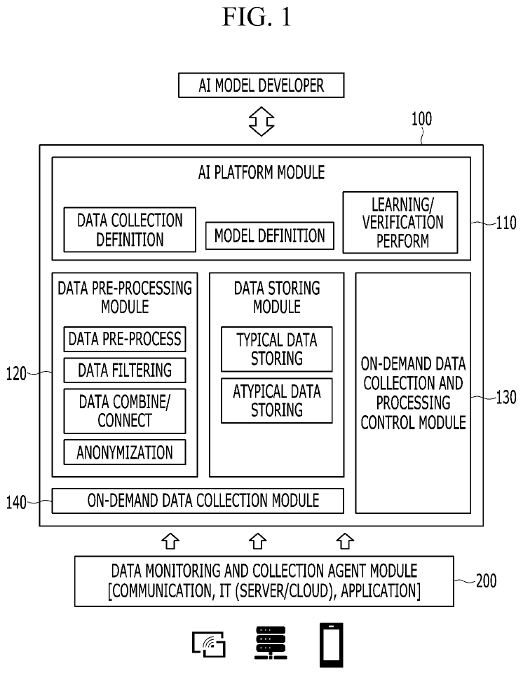

FIG. 1 is a block diagram illustrating an AI system using on-demand data according to an embodiment.

When a person developing an AI model uses an AI system, data for development of the AI model is needed and the data for developing the AI model may be managed in data storage in the AI system 100. In addition, a system, platform, or framework for easily deploying and operating the developed AI model in the cloud or server may also be combined with the AI system.

An AI model for network management and control is also being developed and the developer of the AI model may study the machine learning-based network control model by using the AI system. At this time, the developer of the AI model may develop the network control model in the form of data-based supervised learning based on the AI system.

Since the data-based AI model is highly dependent on data, if the data collection environment is different, the AI model needs to be re-trained using the data collected in the new environment. For the network management, network data is needed to be constantly monitored and stored, and network control and management may be performed based on the stored data. At this time, necessary information (e.g., 5-minute statistic for each port) may be extracted and stored to reduce the size of the always-stored data, which may decrease usability as data for the AI learning.

When storing original data rather than abbreviated information for the AI learning, the data size is too large and it may be difficult to store in the AI system. For example, if packet information or flow information transmitted for 5 minutes is measured and stored instead of 5-minute statistics for each port, the data size to be stored may be increased by 1.5×10⁹ times (1 million packet transmission per second ×300 seconds ×5 information values) and the size will increase again several times when various measurement positions are taken into consideration. Below, an AI system according to an embodiment that can solve data storage space issues, data suitability issues, and security issues by using on-demand data is explained.

Referring to FIG. 1, an AI system 100 according to an embodiment may include an AI platform module 110, a data pre-processing module 120, an on-demand data collection and processing control module 130, and an on-demand data collection module 140. The data monitoring and collection agent module 200 may be connected to the AI system 100 as an external device if necessary.

Referring to FIG. 1, a person who develops an AI model (i.e., developer) may design the AI model through the AI platform module 110 and the designed AI model may be learned and verified within the AI platform module 110.

The developer of the AI model may determine in advance ‘data configuration’ of the data required for the development of the AI model through the data collection definition function in the AI platform module 110. The data configuration determined in the data collection definition function may be as shown in Table 1.

TABLE 1

data ID
measurement profile
Pre-processing profile
data storing process profile (raw, processed)
post data processing profile

In Table 1, data ID may be an identifier used in the AI model.

Referring to Table 1, the data configuration may include contents related to data measurement, data pre-processing method, data storage method, and post-data processing method.

Once the data configuration is predetermined in the AI system, the on-demand data collection and processing control module 130 may control the data measurement for the period and subject defined in the data configuration. The on-demand data collection and processing control module 130 may perform the data measurement using the data monitoring and collection agent module 200 or may perform the data measurement by controlling a monitoring function of an existing device. The measured data may be collected by the on-demand data collection module 140 and the collected data may be in a stream form or a batch form.

When the on-demand data collection module 140 completes the collection, the on-demand data collection and processing control module 140 may instruct the data pre-processing module 120 to pre-process the data, such as filtering, merging, and cleaning. The data pre-processing module 120 may perform pre-processing on collected data according to a pre-processing profile defined in the data configuration.

The data pre-processing module 120 may store the entire raw data or data processed for AI model or a part of the raw data or the processed data in the data storage module based on the data storing process profile of the data configuration. The data pre-processing module 120 may perform pre-processing on the data collected by the on-demand data collection module 140 and provide the pre-processed data to the AI platform module 110 for development or learning for an AI model.

When the pre-processing of the data by the data pre-processing module 120 is finished, the preparation of the processed data is notified to the AI platform module 110 and the AI platform module 110 performs learning based on the processed data, so that the AI model can be developed.

Learning for the AI model learning performed by the AI platform module may be either fully automated as predefined or in a manual form with the developer's part or all intervention.

When the development of the AI model is finished, the AI platform module 110 may apply post-processing policies (extinction, storage through anonymization, etc.) to data according to the post-data processing profile of the data configuration and the post-processed and stored data may be used to develop another AI model.

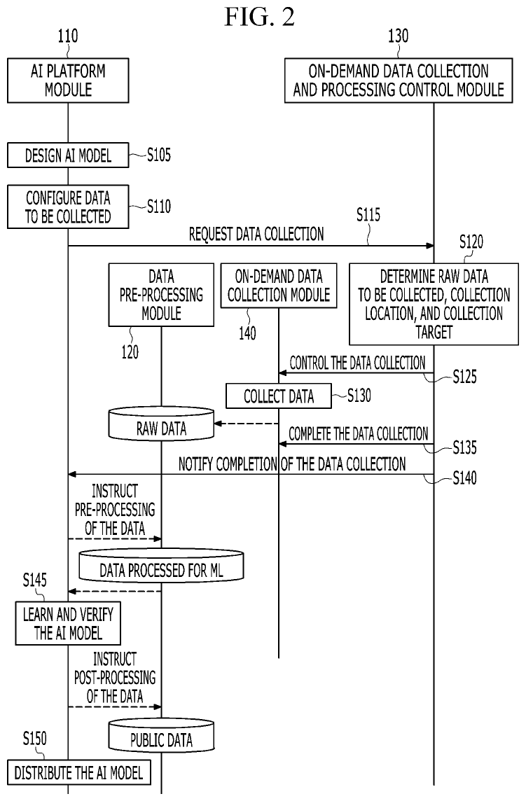

FIG. 2 is a flowchart illustrating a method for collecting data in an AI system according to an embodiment.

Referring to FIG. 2, When the developer of the AI model starts the development of the AI model in the AI system 100, an AI model or machine learning model may be designed in the AI platform module 110 (S105) and configuration of data to be collected including a measurement profile, a pre-processing profile, etc. may be determined (S110). Then, the AI platform module 110 may request data collection to the on-demand data collection and processing control module 130 according to the data configuration (S115).

The on-demand data collection and processing control module 130 may determine raw data that needs to be collected by referring to the measurement profile in the predetermined data configuration and may determine the collection location and the collection target (S120). Then, the on-demand data collection and processing control module 130 may start data measurement and may control so that the data measured by the on-demand data collection module 140 may be received through the data collection control (S125 and S130).

Then, the on-demand data collection and processing control module 130 may determine the end of the data collection, instruct the on-demand data collection module 140 to complete the data collection (S135), and notify the AI platform module 110 that the data collection is completed (S140).

When the data collection is completed, the data pre-processing module 120 may store data processed for AI Model learning or machine learning by pre-processing the raw data into data that can be learned by referring to the pre-processing profile in the predetermined data configuration. The AI platform module 110 may perform model development tasks such as learning and verification of the AI model designed based on the raw data and/or the processed data (S145).

After the AI model learning is completed, the raw data/processed data used for the model development may be stored in the form of public data after post-processing or deleted for security, which may depend on the post-data processing profile in the data configuration.

After that, the AI platform module 110 may be further performed AI model distribution (S150).

As described above, the AI system 100 may request and collect data from the network on demand and pre-process the collected data and use it for the development of the AI models, so that the network does not need to always store unnecessary large-capacity data. That is, data required for the development of the AI model can be collected on demand and used for the development of the AI model.

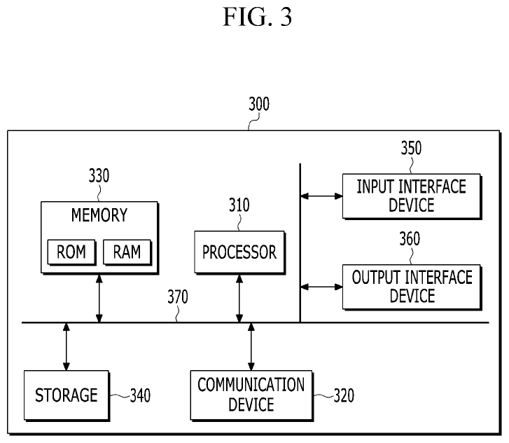

FIG. 3 is a block diagram illustrating an AI system according to another embodiment.

The AI system according to another embodiment may be implemented as a computer system, for example, a computer-readable medium. Referring to FIG. 3, the computer system 300 may include at least one of a processor 310, a memory 320, an input interface device 350, an output interface device 360, and a storage device 340 communicating through a bus 370. The computer system 300 may also include a communication device 320 coupled to the network. The processor 310 may be a central processing unit (CPU) or a semiconductor device that executes instructions stored in the memory 330 or the storage device 340. The memory 330 and the storage device 340 may include various forms of volatile or nonvolatile storage media. For example, the memory may include a read only memory (ROM) or a random-access memory (RAM).

In the embodiment of the present disclosure, the memory may be located inside or outside the processor, and the memory may be coupled to the processor through various means already known. The memory is a volatile or nonvolatile storage medium of various types, for example, the memory may include a read-only memory (ROM) or a random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 320 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. AIso, non-transitory computer-readable media may be any available media that may be accessed by a computer, and may include both computer storage media and transmission media.

The present specification includes details of the number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments. On the contrary, it is intended to cover various modifications and equivalent arrangements included within the spirit and scope of the appended claims.

What is claimed is:

1. A method for collecting data of AI (AI) system, the method comprising:
starting data collection based on a predetermined data configuration of data required for development of AI model when design of the AI model starts on the AI system;
storing raw data collected through the data collection and generating data processed for AI model learning or machine learning (ML) by pre-processing the raw data; and
completing the development of the AI model by learning and validating the AI model designed based on the raw data and/or pre-processed data.

2. The method of claim 1, wherein:
the predetermined data configuration includes a measurement profile of the data required for the development of the AI model, and
the starting data collecting includes
measuring data in a network according to the measurement profile.

3. The method of claim 2, wherein:
the measuring data in a network according to the measurement profile includes
determining raw data to be collected according to the measurement profile and determining collection location and collection target for the raw data.

4. The method of claim 2, wherein:
the predetermined data configuration further includes a pre-processing profile of the data required for the development of the AI model, and
the generating data processed for ML by pre-processing the raw data includes
pre-processing the raw data according to the pre-processing profile.

5. The method of claim 4, wherein:
the predetermined data configuration further includes a data storing process profile of the data required for the development of the AI model, and the method further comprising
storing the raw data and the pre-processed data according to the data storing process profile after the generating data processed for ML by pre-processing the raw data.

6. An artificial intelligence (AI) system using on-demand data, the AI system comprising:
an AI platform module configured to request data collection of data required for development of AI model when design of the AI model starts on the AI system;
an on-demand data collection and processing control module configured to perform the data collection based on a predetermined data configuration of the data required for the development of the AI model; and
a data pre-processing module configured to store the raw data collected through the data collection and generate data processed for AI model learning or machine learning (ML) by pre-processing the raw data,
wherein the AI platform module completes the development of the AI model by learning and verifying the AI model designed based on the raw data and/or pre-processed data.

7. The AI system of claim 6, wherein:
the predetermined data configuration includes a measurement profile of the data required for the development of the AI model, and
the on-demand data collection and processing control module further configured to measure data in a network according to the measurement profile.

8. The AI system of claim 7, wherein:
the on-demand data collection and processing control module further configured to determine the raw data to be collected according to the measurement profile and determine collection location and collection target for the raw data.

9. The AI system of claim 7, wherein:
the predetermined data configuration further includes a pre-processing profile of the data required for the development of the AI model, and
the data pre-processing module further configured to pre-processes the raw data according to the pre-processing profile.

10. The AI system of claim 9, wherein:
the predetermined data configuration further includes a data storing process profile of the data required for the development of the AI model, and
the data pre-processing module configured to store the raw data and the data processed for the ML in a data storage module according to the data storing process profile.

11. An artificial intelligence (AI) system collecting data on demand, the AI system comprising:
a processor, a memory, and a communication device, wherein
the processor executes a program stored in the memory to perform:
starting data collection through the communication device based on a predetermined data configuration of data required for development of AI model when design of the AI model starts on the AI system;
storing raw data collected through the data collection and generating data processed for AI model learning or machine learning (ML) by pre-processing the raw data; and
completing the development of the AI model by learning and validating the AI model designed based on the raw data and/or pre-processed data.
